(19) United States
(12) Patent Application Publication
(10) Pub. No.: US 2008/0311240 A1
(43) Pub. Date: Dec. 18, 2008

(54) Steam Agglomeration of Polyols

(75) Inventors: Robert Henri-Marcel Stouffs, Ferrara (IT); Michel Henri Andre Gonze, Bruxelles (BE)

Correspondence Address: FISH & RICHARDSON P.C., PO BOX 1022, MINNEAPOLIS, MN, 55440-1022, US

(73) Assignee: CARGILL INCORPORATED, Wayzata, MN (US)

(21) Appl. No.: 11/570,826

(22) PCT Filed: May 23, 2005
(86) PCT No.: PCT/EP2005/005544

§ 371 Date: Aug. 20, 2008

(30) Foreign Application Priority Data
Jun. 17, 2004 (EP) 04253616.9

(51) Int. Cl. A23L 1/236; A23G 4/06; A23G 4/20

(52) U.S. Cl. 426/5; 426/548

(57) ABSTRACT

The current invention relates to steam agglomeration of polyols. In a typical embodiment steam-agglomerated sorbitol powder is provided. The steam-agglomerated sorbitol is applicable in tablets and chewing gum cores. Tablets, chewing cores and hard-coated chewing gum are disclosed as well.

### TECHNICAL FIELD

The current invention relates to steam agglomeration of polyols. Product of low quality can be converted into direct compressible powders which can be applied in tabletting and chewing gum.

### BACKGROUND OF INVENTION

Polyol powders are prepared according different technologies. Polyols can be crystallised, freeze-dried, extruded, or spray-dried.

U.S. Pat. No. 4,408,041, U.S. Pat. No. 6,120,612, U.S. Pat. No. 5,932,015 all relate to different process for crystallising maltitol.

U.S. Pat. No. 5,160,680 describes a method of preparing directly compressible granulated mannitol wherein mannitol powder is subjected to an extrusion treatment.

Currently there is a need for a simple, cost-effective process which allows obtaining polyol solids of high quality and which can convert low quality powders into solids of high quality.

The current invention provides such a process.

### SUMMARY OF INVENTION

The current invention relates to a process for agglomerating a polyol and said process is comprising the following steps:

a) taking a polyol in solid form,

b) feeding the polyol in solid form through a flow of steam and/or hot gas for obtaining agglomerated solid polyol, preferably through a flow of steam or hot moistened air,

c) collecting the agglomerated solid polyol,

d) optionally drying of agglomerated solid polyol.

The current invention relates to a process wherein said agglomerated solid polyol is collected and/or dried on a fluid bed or in a rotary drum. In said rotary drum the agglomerated solid polyol is dried by applying hot gas.

The current invention further relates to a process wherein the polyol is sorbitol. The solid form of sorbitol (is feed substrate) is selected from the group consisting of sorbitol crystals, crystalline mass of sorbitol, sorbitol dust, spray-dried sorbitol and mixtures thereof, preferably sorbitol dust.

The current invention relates to a process for agglomerating sorbitol dust and said process is comprising the following steps:

a) taking sorbitol dust,

b) feeding the sorbitol dust through a flow of steam and/or hot gas for obtaining agglomerated solid sorbitol, preferably through a flow of steam or hot moistened air,

c) collecting the agglomerated solid sorbitol,

d) optionally drying of agglomerated solid polyol.

Furthermore, the current invention relates to a process which comprising the following steps:

a) taking sorbitol dust,

b) feeding sorbitol dust through a flow of steam for obtaining steam-agglomerated sorbitol,

c) collecting and drying steam-agglomerated sorbitol on fluid bed,

d) optionally recycling steam-agglomerated sorbitol into step a) until particle size of steam-agglomerated sorbitol is suitable for application in chewing gum and/or tablets.

In a further embodiment, said sorbitol dust is a by-product of the crystallisation and/or solidification process of sorbitol syrup or sorbitol melt.

Furthermore, the current invention discloses the new product, steam-agglomerated polyol obtainable according to the process of the current invention. In a more specific embodiment, the current invention relates to steam-agglomerated sorbitol powder obtainable according to the currently disclosed process.

The current invention relates to tablets containing steam-agglomerated polyol and/or steam-agglomerated sorbitol, or chewing gum core containing steam-agglomerated polyol and/or steam-agglomerated sorbitol. The current invention further relates to sugar-free hard coated chewing gum comprising a hard coating and a chewing gum core containing steam-agglomerated polyol according to the current invention.

The current invention relates to the use of steam-agglomerated polyol for preparing tablets or for preparing cores of chewing gum.

The current invention further relates to the use of steam-agglomeration to upgrade the quality of polyol dust into steam-agglomerated polyol, more specifically the use wherein the polyol is sorbitol.

### FIGURES

FIG. 1: is a schematic presentation of suitable equipment and process for steam-agglomeration:
Material Flow: the powdery product descends the hopper (1), uniformly distributed by the metering brush (4) and by the interchangeable grid (5), on the fluid bed (3), passing through a hot air and steam flow which comes from diffuser (2), and then goes on into the dryer (8) as far as the grading sieve (10). The possible particles of fine product recovered by cyclone (6) are discharged by valve (7), and then recycled.
Steam flow: from the main supply, the steam is conveyed to heat exchanger (9) and to steam diffuser (2) and to the hollow space of the suction hood.

FIG. 2: graph showing tensile strength of tablets prepared with steam-agglomerated sorbitol obtained from sorbitol dust. Tensile strength is expressed in function of increasing compression force.

FIG. 3: graph showing ejection force of tablets prepared with steam-agglomerated sorbitol obtained from sorbitol dust.

FIG. 4: graph showing tensile strength of tablets prepared with steam-agglomerated sorbitol (MS 0128) and a mixture of steam-agglomerated sorbitol obtained from sorbitol dust, and sorbitol crystals in a weight ratio of 70/30.(MS 0129) Tensile strength is expressed in function of increasing compression force.

FIG. 5: graph showing the hardness of chewing gum cores containing a mixture of steam-agglomerated sorbitol and sorbitol crystals (weight ratio 70:30) compared with hardness of chewing gum cores prepared with sorbitol crystals. The hardness is measured after 30 minutes, 24 hours and 1 week.

### DETAILED DESCRIPTION

The current invention relates to a process for agglomerating a polyol and said process is comprising the following steps:

a) taking a polyol in solid form,

b) feeding the polyol in solid form through a flow of steam and/or hot gas for obtaining agglomerated solid polyol, preferably through a flow of steam or hot moistened air,

c) collecting the agglomerated solid polyol,

d) optionally drying of agglomerated solid polyol.

The polyol is having the following chemical formula CₙH₂ₙ₊₂Oₙ, and which is a solid material at room temperature. (i.e. 20-25° C.). This chemical formula is typical for hydrogenated carbohydrates but the polyol of the current invention is not necessarily obtained by hydrogenation of the carbohydrate. Some of these polyols (e.g. erythritol) are obtainable via other chemical processes and/or microbial processes or fermentation.

Typically, the polyol is selected among the tetritols, pentitols, hexitols, hydrogenated disaccharides, hydrogenated trisaccharides, hydrogenated tetrasaccharides, hydrogenated maltodextrins and mixtures thereof.

More specifically the polyol can be selected from the group consisting of erythritol, threitol, arabinitol, xylitol, ribitol, allitol, altritol, gulitol, galactitol, mannitol, sorbitol, talitol, maltitol, isomaltitol, isomalt, lactitol, and mixtures thereof.

Through the flow of steam, hot moistened air and/or hot gas the polyol powder is agglomerated to a solid material. The hot gas can be air or any inert gas, e.g. nitrogen gas.

The current invention relates to a process wherein said agglomerated solid polyol is collected and/or dried on a fluid bed. The polyol powder is fed, for example with a batch feeding hopper, and is falling through a stainless steel net on a fluid bed. There the finely distributed powder is passing through the flow of steam and/or hot gas and agglomeration is taking place.

The current invention is further characterised in that the obtained agglomerated solid material is collected in a rotary drum.

In the rotary drum drying can take place by applying a uniform flow of hot gas, preferably hot air.

The dried material can be further stabilised by applying a uniform flow of cold gas, preferably air.

In a typical example, the polyol powder is sorbitol powder. The powder (=feed substrate) is selected from the group consisting of sorbitol crystals, crystalline mass of sorbitol, sorbitol dust, spray-dried sorbitol and mixtures thereof, preferably sorbitol dust. Typically sorbitol dust is a kind of by-product in other solidification processes or crystallisation processes of sorbitol. For example sorbitol can be a by-product of the Readco or Buck Sanders technology.

The crystalline mass of sorbitol is containing crystalline as well as amorphous material.

The current invention relates to a process for agglomerating sorbitol dust and said process is comprising the following steps:

a) taking sorbitol dust,

b) feeding the sorbitol dust through a flow of steam and/or hot gas for obtaining agglomerated solid sorbitol, preferably through a flow of steam or hot moistened air,

c) collecting the agglomerated solid sorbitol,

d) optionally drying of agglomerated solid polyol.

The current invention relates to a process for agglomerating sorbitol dust and said process is comprising the following steps:

a) crystallising sorbitol syrup at elevated temperature in a mixing device, for obtaining crystallised sorbitol,

b) separating crystallised sorbitol from the formed sorbitol dust,

c) taking sorbitol dust, and feeding the sorbitol dust through a flow of steam and/or hot gas for obtaining agglomerated solid sorbitol, preferably through a flow of steam or hot moistened air,

d) collecting the agglomerated solid sorbitol,

e) optionally drying of agglomerated solid polyol.

The sorbitol syrup is obtainable from a hydrogenation of a glucose syrup which is containing a high quantity of glucose. Typically the glucose syrup is containing at least 92%, preferably 95%, more preferably at least 99% glucose (based on the dry substance of the glucose syrup). The obtained sorbitol syrup can then be crystallised in a melt crystallisation device, continuous mixing device, and the like. A typical device is a Readco crystallising device or Buck Sanders. The products obtained are sorbitol crystals and/or crystalline mass of sorbitol, and as a by-product the so-called sorbitol dust.

The current invention relates to a process which comprising the following steps:

a) taking sorbitol dust,

b) feeding sorbitol dust through a flow of steam for obtaining steam-agglomerated sorbitol,

c) collecting and drying steam-agglomerated sorbitol on fluid bed,

d) optionally recycling steam-agglomerated sorbitol into step a) until particle size of steam-agglomerated sorbitol is suitable for application in chewing gum and/or tablets.

Actually, the steam agglomeration process can be used to upgrade the quality of any type of sorbitol powder, preferably a sorbitol powder of low quality and obtainable as a by-product of any other type of upgrading process (solidification, and/or crystallisation).

The process is typically upgrading the quality of sorbitol dust into a high quality steam-agglomerated sorbitol powder. Surprisingly, the quality of the steam-agglomerated product obtained from sorbitol dust is higher than the quality of steam-agglomerated sorbitol powder obtained from crystalline sorbitol.

A crystallisation process of sorbitol for example by applying Buck Sanders or Readco technology, can deliver more than 10% dust, even up to 30% dust might be produced. The current invention allows avoiding recycling via redissolution, but provides a process which results in steam-agglomerated sorbitol powder obtainable according to the process of the current invention.

This steam-agglomerated sorbitol powder is a direct compressible powder having unique tabletting properties. The steam-agglomerated sorbitol powder can be used as such or in combination with other sorbitol solids and/or crystals. In those combinations the weight ratio of steam-agglomerated sorbitol to sorbitol solids and or crystals is from 99:1 to 50:50, preferably from 80:20 to 60:40, more preferably 70:30.

The current invention relates to tablets containing said steam-agglomerated polyol and/or steam-agglomerated sorbitol, preferably steam-agglomerated sorbitol and/or in combination with other sorbitol solids and/or crystals. The tablets are containing steam-agglomerated polyol powder obtainable according to the process of the current invention. The tablets further can contain other sorbitol solids.

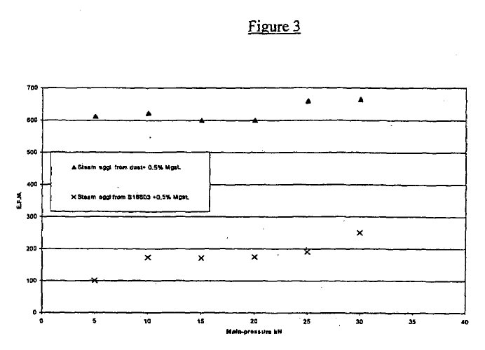

The tablets containing steam-agglomerated polyol preferably steam-agglomerated sorbitol powder are much harder than tablets prepared with other types of sorbitol powder. Furthermore, very high ejection forces at low compression force are obtained for the tablets containing this steam-agglomerated sorbitol powder, preferably steam-agglomerated sorbitol powder obtainable from sorbitol dust (see FIG. 3,4).

As a lubricant agent in tablet formation, magnesium stearate, calcium stearate, stearic acid, sucrose fatty acid esters, talc etc. can be applied.

The current invention further relates to a chewing gum core containing steam-agglomerated polyol and/or steam-agglomerated sorbitol powder preferably steam-agglomerated sorbitol, and/or in combination with other sorbitol solids and/or crystals. The chewing gum cores are containing steam-agglomerated polyol obtainable according to the process of the current inventions. The chewing fum cores further can comprise another polyol selected from the group consisting of erythritol, mannitol, maltitol, isomalt, xylitol and mixtures thereof. Said polyol can be provided as a syrup, solid, crystals or mixtures thereof.

These cores containing steam-agglomerated polyol, preferably steam-agglomerated sorbitol are less sticky and the texture is improved for the coating, when compared with standard sorbitol powder. Actually for obtaining chewing gum cores with the same texture less steam-agglomerated sorbitol is required compared to the standard sorbitol powder.

The current invention further relates to a sugar-free coated chewing gum comprising a sugar-free hard coating and a core containing the steam-agglomerated sorbitol powder of the current invention. The sugar-free hard coating can be prepared from a polyol selected from the group consisting of erythritol, sorbitol, mannitol, maltitol, isomalt, xylitol and mixtures thereof, and the polyol can be provided as a syrup, solid, crystals, or mixtures thereof.

The current invention relates to the use of steam-agglomerated polyol for preparing tablets and/or for preparing cores of chewing gum. The texture of the chewing gum core containing steam-agglomerated polyol, preferably steam-agglomerated sorbitol is improved in comparison to chewing gum core prepared with other types of sorbitol powder. Furthermore, the stickiness of the resulting chewing gum core has reduced. Actually in order to obtain a chewing gum core with a texture comparable to the standard grades, the steam-agglomerated polyol, preferably steam-agglomerated sorbitol is needed in a smaller quantity. The hardness is increased when applying the same amount of steam-agglomerated sorbitol powder.

The current invention further relates to the use of steam-agglomeration to upgrade the quality of polyol dust into steam-agglomerated polyol, more specifically the use wherein the polyol is sorbitol.

The current invention has the following advantages:

simple, cost-effective process

low quality dust is upgraded into high quality direct compressible powder with unique tabletting properties

the tablets have improved properties

the chewing gum core has improved properties, the texture is improved and the stickiness is less pronounced.

The current invention is further illustrated by way of the following examples:

### EXAMPLE 1

### Steam Agglomeration of Sorbitol

Feed (sorbitol-dust, Cerestar):

| | |
|---|---|
| moisture | 0.45% |
| bulk density | 0.629 kg/l |
| packed density | 0.827 kg/l |
| average granulometry | 72μ |

The steam agglomeration of this feed took place in the Instantizer RC-R3000 and the following parameters were applied:

| | |
|---|---|
| Grid: | 1.6b*mm, 3 × 49 cm |
| Steam pressure: | 0.5 bar |
| T fluid bed IN: | 87° C. |
| T dryer IN: | 80° C. |
| Flowrate: | 140 kg/h |

*free area of the whole grid, in this case 3 cm (on 4) for a length of 49 cm.

The product at the outlet had the following characteristics:

| | |
|---|---|
| Moisture | 0.48% |
| Flowability index | 0.71 |
| Bulk Density | 0.436 kg/l |
| Packed Density | 0.606 kg/l |
| Average granulometry. | 159 micron |
| Fraction. > 1.25 mm | 1.2% |

Bulk Density (=Loose Bulk Density) and Packed Density (=Packed Bulk Density) are measured as follows:

Use a 250-mL graduated cylinder having a graduated section 24 to 26 cm long, and place on a horizontal surface. Use a Pyrex powder funnel (Corning No. 6220) having a stem 30 mm long and an outside diameter of 17 mm. By means of a ring support on a ring stand, suspend the funnel in a vertical position with the stem centered inside the cylinder, 6 cm above the 250-mL mark.

Weigh the 250-mL cylinder on a torsion balance, and return to the assembly. With the aid of a spoon or spatula, carefully add sample to the powder funnel until the cylinder is filled (level) to the 250-mL mark. Determine the weight of contents (loose) to the nearest 0.1 g.

Bulk (loose) and packed densities are calculated from the sample weight and volumes.

Center the cylinder containing loose sample on the vibrator deck, and hold upright with a loose-fitting ring support on a ring stand. Start the vibrator, and turn up the rheostat to the point where the cylinder begins to bounce rather vigorously, usually indicated by a break in the vibrating rhythm between the cylinder and deck. Vibrate for 5 minutes, then note the volume of packed sample.

$$Loose Bulk Density , g \text{/} mL = \frac{Loose Sample Wt . , g}{250 mL Sample}$$

$$Packed Density , g \text{/} mL = \frac{Loose Sample Wt . , g}{Packed Sample , mL}$$

Average Granulometry, or Median, is the particle diameter at which half of the distribution (half of the volume percent, or weight percent) is larger and half is smaller. The particle size distribution is measured according to Air Stream Sieving.

Flowability or intrinsic flowability is a property of a powder to flow evenly under the action of gravity and other forces. It is measured with a Flodex Tester by Hanson Research Corporation, Chatsworth USA, and expressed as flowability index over an arbitrary scale of 0.4-4 cm. The index represents the ability of the powder to flow through a hole in a plate and is expressed as the inverse of the diameter (in cm) of the smallest hole through which the powder passes.

### EXAMPLE 2

### Steam Agglomerated Sorbitol from Sorbitol Dust

The steam-agglomerated sorbitol from example 1 (prepared from sorbitol dust) was applied for preparing tablets on the Fette tablettizer, (Type Perfecta 1000) 0.5% magnesium stearate based on dry substance of sorbitol solids was added. The product was mixed for 3 minutes in a low shear rotating tubular mixer (Twist PBI 10975) and applied on the Fette tablettizer. 22 punches were used. The material was compressed at a speed of 20.000 tablets/h. The tablets had a diameter of 1.1 cm and a weight of 350 mg.

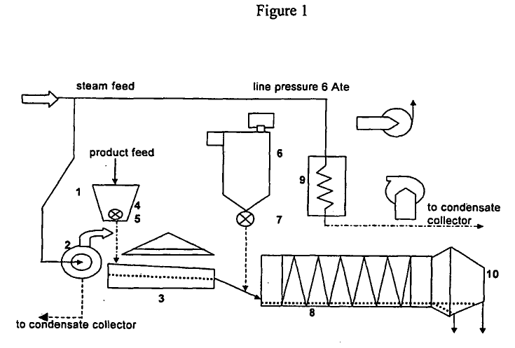

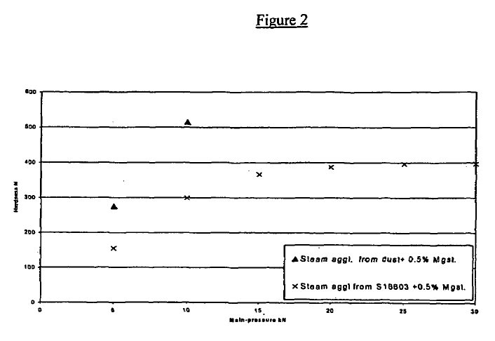

The properties of the prepared tablets were evaluated by measuring their tensile strength as a function of the compression force. The tensile strength was measured with a Fette Checkmaster 3 (see FIG. 2).

In FIG. 2 the tensile strength of steam-agglomerated sorbitol is depicted as a function of the compression force.

Tensile Strength represents the tension where the material breaks. It can be measured as hardness in Newton, in function of compression force in KNewton main pressure.

In FIG. 3 the ejection force is given for the tablets prepared with steam-agglomerated sorbitol from sorbitol dust.

### EXAMPLE 3

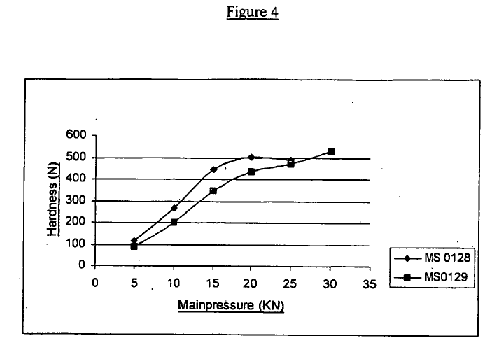

The tabletting process of Example 2 was repeated for the steam-agglomerated sorbitol powder (MS 0128) and for (MS 0129) where the steam-agglomerated sorbitol powder was substituted with a mixture of steam-agglomerated sorbitol powder and sorbitol crystals (C⋆ Sorbidex S 16656) (Cerestar) in a weight ratio of 70:30 (MS 0129). The result is displayed in FIG. 4.

### EXAMPLE 4

### Chewing Gum

The equipment was heated with a waterbath at a temperature of 49° C. 21 g of the gum base was introduced and mixed for 2 minutes. 42.5 g of sorbitol powder (mixture of steam-agglomerated sorbitol powder and sorbitol crystals in ratio of 70/30) was added and the total was mixed for 12 minutes. Finally 1.43 g maltitol syrup (C⋆Maltidex, 74% d.b.). was added and was mixed into the mixture during 25 minutes.

The mass was laminated to 4 mm and stored at 25° C. and 65% RH, for respectively 30 minutes, 24 hours and 1 week.

The hardness was measured with the texture analyser with the following parameters applied:

penetration depth: 2 mm.

Spindle: 2 mm

Pre-test speed: 1 mm/sec

Test speed: 0.5 mm/sec

Post test speed: 5 mm/sec

The measurements were done on the chewing gum stored for 30 minutes, 24 hours and 1 week.

In a comparative test, chewing gums and their corresponding measurements were performed wherein the mixture containing steam-agglomerated sorbitol was replaced with sorbitol powder C⋆ Sorbidex S 16602 (Cerestar) or sorbitol powder C⋆ Sorbidex S 16603 (Cerestar).

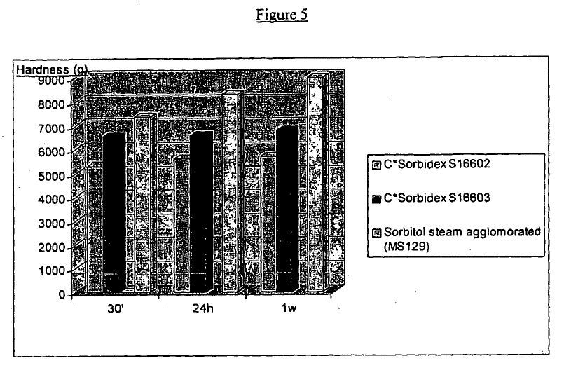

The hardness was measured and the results are displayed in FIG. 5.

The chewing gum prepared with steam-agglomerated sorbitol was harder than the other chewing gums.

1-22. (canceled)

23.A process for agglomerating a polyol, wherein said process comprises the following steps:
a) providing a polyol in solid form,
b) feeding the polyol in solid form through a flow of steam and/or hot gas for obtaining agglomerated solid polyol,
c) collecting the agglomerated solid polyol,
d) optionally drying of agglomerated solid polyol.

24. The process of claim 23, wherein the gas is moistened air.

25. The process of claim 23, wherein the agglomerated solid polyol is collected and/or dried on a fluid bed.

26. The process of claim 23, wherein the agglomerated solid polyol is collected and/or dried in a rotary drum.

27. The process of claim 26, wherein the agglomerated solid polyol is dried in the rotary drum by applying hot gas.

28. The process of claim 23, wherein the polyol is sorbitol.

29. The process of claim 28, wherein the solid form of sorbitol is selected from the group consisting of sorbitol crystals, crystalline mass of sorbitol, sorbitol dust, spray-dried sorbitol and mixtures thereof.

30. The process of claim 28, wherein the solid form of sorbitol is sorbitol dust.

31. Steam-agglomerated polyol obtainable by the process of claim 23.

32. Tablets containing the steam-agglomerated polyol of claim 31.

33. Chewing gum core containing the steam-agglomerated polyol of claim 31.

34. A process for agglomerating sorbitol dust, wherein said process comprises the following steps:
a) providing sorbitol dust,
b) feeding the sorbitol dust through a flow of steam and/or hot gas to obtain agglomerated solid sorbitol,
c) collecting the agglomerated solid sorbitol, and
d) optionally drying the agglomerated solid polyol.

35. The process of claim 34, wherein the gas is moistened air.

36. Steam-agglomerated sorbitol powder obtained by the process of claim 34.

37. Tablets containing the steam-agglomerated sorbitol powder of claim 36.

38. The tablets of claim 37, further comprising sorbitol crystals.

39. Chewing gum core containing the steam-agglomerated sorbitol powder of claim 36.

40. The chewing gum core of claim 39, further comprising sorbitol crystals.

41. Sugar-free hard-coated chewing gum comprising a hard coating and the chewing gum core of claim 39.

42. A process for agglomerating sorbitol dust, wherein said process comprises the following steps:
crystallizing sorbitol syrup at elevated temperature in a mixing device to obtain crystallised sorbitol,
separating the crystallized sorbitol from the formed sorbitol dust,
providing sorbitol dust and feeding the sorbitol dust through a flow of steam and/or hot gas to obtain agglomerated solid sorbitol,
collecting the agglomerated solid sorbitol, and
optionally drying the agglomerated solid polyol.

43. The process of claim 42, wherein said hot gas is hot moistened air.

44. Steam-agglomerated sorbitol powder obtained by the process of claim 42.

45. Tablets containing the steam-agglomerated sorbitol powder of claim 44.

46. The tablets of claim 45, further comprising sorbitol crystals.

47. A chewing gum core containing the steam-agglomerated sorbitol powder of claim 42.

48. The chewing gum core of claim 47, further comprising sorbitol crystals.

49. Sugar-free hard coated chewing gum comprising a hard coating and a chewing gum core of claim 47.

50. The process of claim 23, wherein said process comprises the following steps:
a) providing sorbitol dust,
b) feeding sorbitol dust through a flow of steam to obtain steam-agglomerated sorbitol,
c) collecting and drying the steam-agglomerated sorbitol on a fluid bed, and
d) optionally recycling the steam-agglomerated sorbitol into step a) until the particle size of steam-agglomerated sorbitol is suitable for application in chewing gum and/or tablets.

51. The process of claim 50, wherein the sorbitol dust is a by-product of the crystallization and/or solidification process of sorbitol syrup or sorbitol melt.
